(19) United States
(12) Patent Application Publication
(10) Pub. No.: US 2025/0358190 A1
(43) Pub. Date: Nov. 20, 2025

(54) MANAGEMENT SYSTEM, MANAGEMENT METHOD, AND PROGRAM

(71) Applicant: Nippon Telegraph and Telephone Corporation, Tokyo (JP)

(72) Inventors: Sho KANEMARU, Musashino-shi, Tokyo (JP); Aya SUZUKI, Musashino-shi, Tokyo (JP); Kensuke TAKAHASHI, Musashino-shi, Tokyo (JP); Satoshi KONDO, Musashino-shi, Tokyo (JP)

(21) Appl. No.: 18/869,427

(22) PCT Filed: Jun. 8, 2022
(86) PCT No.: PCT/JP2022/023138

§ 371 Date: Nov. 26, 2024

(51) Int. Cl. H04L 41/0895

(52) U.S. Cl. CPC H04L 41/0895

(57) ABSTRACT

A management system that manages resources of a network includes a channel management device that creates an information sharing channel according to an identifier related to a network slice for each construction order of the network slice, and a plurality of resource information sharing devices and that share resource information necessary at the time of execution of the construction order between domains of the network via the information sharing channel.

### TECHNICAL FIELD

The present invention relates to a management system, a management method, and a management program.

### BACKGROUND ART

Conventionally, there is a management system that manages NW resources between a terminal and a server.

The management system includes a controller that manages NW resources for each network slice obtained by logically or physically dividing the NW resources. For example, there is a controller that manages the NW resource of a domain A. There is a controller that manages the NW resource of a domain B. There is a controller that manages a connection gateway of a domain C that connects the domain A and the domain B.

In addition, the management system includes an end-to-end controller that manages each controller, to manage end-to-end communication between the terminal and the server. For example, there is an end-to-end controller that manages a controller in the domain A, a controller in the domain B, and a controller in the domain C.

When network slices are created end-to-end, an end-to-end controller and a controller for each domain need to cooperate to distribute information (for example, area information, band information, and delay information) necessary for network slice management to each domain. For example, the end-to-end controller transmits band information to the controller in the domain A.

At that time, in order to utilize resource information (for example, Slice ID (SID) and IP address) created in a certain domain for resource creation in another domain, it is necessary to distribute the resource information between domains. For example, the controller of the domain A transmits the SID created in the domain A to the controller of the domain C. The controller in the domain B transmits the IP address created in the domain B to the controller in the domain C. Thereafter, the controller in the domain C transmits the received SID and IP address to the domain C.

In addition, in order to improve the efficiency of maintenance operation after operation of the constructed network slice, a concept of Closed Loop Automation in which an end-to-end controller acquires fault management (FM) information and performance management (PM) information distributed from each NW resource of each domain, determines the presence or absence of a service influence based on the FM/PM information, and performs an operation in a controller of each domain as necessary has been proposed in ETSI ZSM and the like.

For example, when PM information (throughput) is issued from the NW resource of the domain A and FM information (bandwidth excess) is accordingly issued from the controller of the domain A, the end-to-end controller determines, based on the FM/PM information, the presence or absence of an influence on an end-to-end service provided by the server to the terminal, and causes the controller of the predetermined domain to execute Closed Loop when there is an influence on the service. Specifically, a predetermined controller repeatedly executes monitoring, analysis, processing determination, and processing execution in that order.

Here, a technology for transmitting and receiving information between domains will be described. When resource information and the like are transmitted and received between domains, the REST API and the Pub/Sub protocol are used.

The REST API is an API including a method and a URI defined based on a design idea of a web system called representational state transfer. Data transmission and reception can be performed in a client-server type of 1:1.

For example, a client 1 in the domain A transmits data to the server 1 in the domain B in a message “POST/user”. A client 2 in the domain A acquires data from the server 2 in the domain B by a message “GET/user”.

The Pub/Sub protocol is a lightweight messaging protocol utilizing a data distribution unit called topic. Not only 1:1 but also 1:N communication is supported, and data transmission and reception can be performed without considering the format of data. Specifically, there are message queue telemetry transport (MQTT), advanced message queuing protocol (AMQP), and the like.

For example, the Publisher in the domain A publishes “Topic:1” and publishes “Topic:2”. The Subscriber in the domain B subscribes to “Topic:1” via the Broker of “Topic:1”. Each of the three Subscribers 1 to 3 in the domain C subscribes to “Topic:2” via the Broker of “Topic:2”.

### CITATION LIST

### Non Patent Literature

Non Patent Literature 1: Nagaoka Kenichi, “RESTful API no URI sekkei (endo pointo sekkei)) (in Japanese) (RESTful API URI design (endpoint design)”, Qiita, [online], [retrieved on May 25, 2022] <URL: https://qiita.com/NagaokaKenichi/items/6298eb8960570c7ad2e9>

### SUMMARY OF INVENTION

### Technical Problem

In the information distribution using the REST API, since it is necessary to mutually recognize the format of the endpoint information and the data of the opposing device when distributing information between domains, it is necessary for the opposing domain device to detect and follow a change in the endpoint information and the data format due to construction or the like of another domain.

In the information distribution using the Pub/Sub protocol, since it is necessary to share the topic information between both Publisher and Subscriber in advance, in a case where the information sharing target is dynamically changed as in the network slice creation/change/deletion processing, it is necessary to dynamically transmit the topic information to both Publisher and Subscriber.

The present invention has been made in view of the above circumstances, and an object of the present invention is to provide a technique capable of easily distributing information distributed in a management system.

### Solution to Problem

The management system according to an aspect of the present invention is a management system that manages resources of a network, the system including a management device that creates an information sharing channel according to an identifier related to a network slice for each construction order of the network slice, and a plurality of sharing devices that share resource information necessary at the time of execution of the construction order between domains of the network via the information sharing channel.

The management system according to an aspect of the present invention is a management system that manages resources of a network, the system including a management device that creates an information sharing channel according to an identifier related to a network slice for each network slice constructed in each domain of the network, a plurality of registration devices that register maintenance and operation information necessary for maintenance and operation of a network resource in each network slice with respect to each of a plurality of the information sharing channels, and an acquisition device that acquires the maintenance and operation information from a predetermined information sharing channel among the plurality of information sharing channels.

The management method according to an aspect of the present invention is a management method performed by a management system that manages resources of a network, the method including creating, by a management device, an information sharing channel according to an identifier related to a network slice for each construction order of the network slice, and sharing, by a plurality of sharing devices, resource information necessary at the time of execution of the construction order between domains of the network via the information sharing channel.

The management method according to an aspect of the present invention is a management method performed by a management system that manages resources of a network, the method including creating, by a management device, an information sharing channel according to an identifier related to a network slice for each network slice constructed in each domain of the network, registering, by a plurality of registration devices, maintenance and operation information necessary for maintenance and operation of a network resource in each network slice with respect to each of a plurality of the information sharing channels, and acquiring, by an acquisition device, the maintenance and operation information from a predetermined information sharing channel among the plurality of information sharing channels.

A management program according to an aspect of the present invention causes a computer to function as the above management system.

### Advantageous Effects of Invention

According to the present invention, it is possible to provide a technology capable of easily distributing information distributed in the management system.

### BRIEF DESCRIPTION OF DRAWINGS

FIG. 1 is a diagram illustrating a configuration example of a management system.

FIG. 2 is a diagram illustrating a flow of resource information distribution processing at the time of receiving a construction order.

FIG. 3 is a diagram illustrating a processing flow at the time of receiving an obsolete order.

FIG. 4 is a diagram illustrating a FM/PM information distribution processing flow.

FIG. 5 is a diagram illustrating the FM/PM information distribution processing flow.

FIG. 6 is a reference diagram at the time of describing an effect.

FIG. 7 is a reference diagram at the time of describing the effect.

FIG. 8 is a reference diagram at the time of describing the effect.

FIG. 9 is a reference diagram at the time of describing the effect.

FIG. 10 is a diagram illustrating a hardware configuration example of a channel management device.

### DESCRIPTION OF EMBODIMENTS

Hereinafter, embodiments of the present invention will be described with reference to the drawings. In the drawings, the same reference signs are assigned to the same parts, and the description thereof is omitted.

### Summary of Invention

The present invention relates to a method for suitably distributing resource information between domains at the time of constructing a network slice, and a method for suitably distributing FM/PM information of each domain between a domain and an end-to-end controller after constructing a network slice, in dynamically managing a network slice across domains.

Specifically, the present invention creates a resource information sharing channel for sharing resource information distributed among controllers in each domain for each network slice construction order (each network slice ID (NSID)), and realizes resource information distribution between domains at the time of service order (SO) input using the resource information sharing channel.

Specifically, the present invention creates an FM/PM information sharing channel for sharing FM/PM information distributed between a controller and an end-to-end controller for each slice (for each network slice subnet ID (NSSID)) constructed in each domain, and realizes distribution of FM/PM information necessary for maintenance and operation of a network slice using the FM/PM information sharing channel.

### Configuration Example of Management System

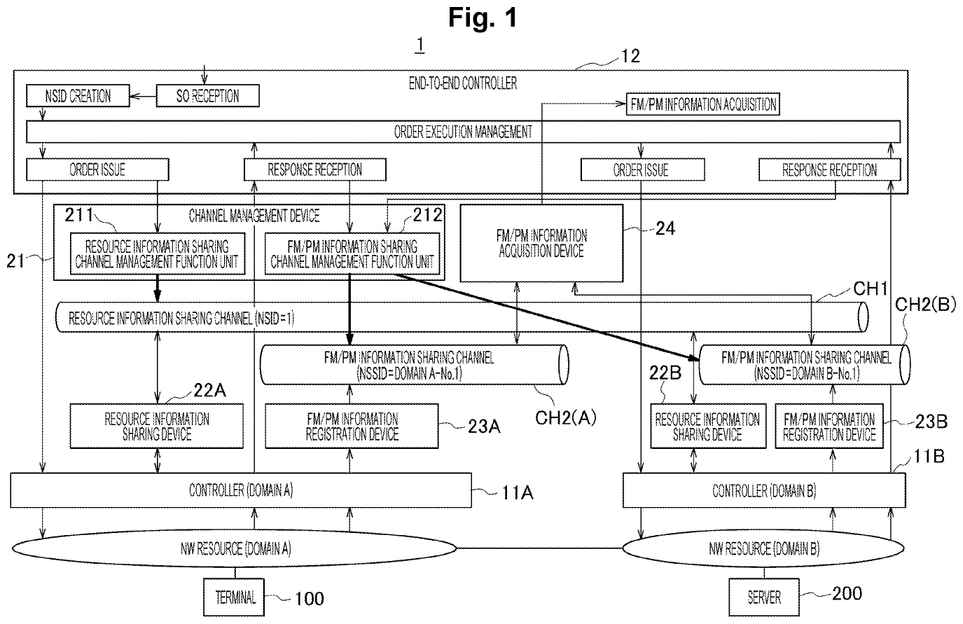

FIG. 1 is a diagram illustrating a configuration example of a management system 1 according to the present embodiment.

The management system 1 is a management system that manages resources of a network, and includes a controller 11A that manages NW resources of a domain A between a terminal 100 and a server 200, a controller 11B that manages NW resources of a domain B adjacent to the domain A, and an end-to-end controller 12 that manages the controller 11A of the domain A and the controller 11B of the domain B.

In addition, the management system 1 includes a channel management device 21, two resource information sharing devices 22A and 22B, two FM/PM information registration devices 23A and 23B, and an FM/PM information acquisition device 24.

The channel management device (management device) 21 includes a resource information sharing channel management function unit 211 and an FM/PM information sharing channel management function unit 212.

The resource information sharing channel management function unit 211 has a function of creating a resource information sharing channel according to an identifier (NSID) related to a network slice for each network slice construction order. Specifically, the resource information sharing channel management function unit 211 has a function of creating/changing/deleting a resource information sharing channel CH1 for sharing resource information between the controllers 11A and 11B of the domains A and B.

The FM/PM information sharing channel management function unit 212 has a function of creating an FM/PM information sharing channel according to an identifier (NSSID) related to a network slice for each network slice constructed in each domain of the network. Specifically, the FM/PM information sharing channel management function unit 212 has a function of creating/changing/deleting an FM/PM information sharing channel CH2 (A) for sharing FM/PM information between the controller 11A and the end-to-end controller 12 and an FM/PM information sharing channel CH2 (B) for sharing FM/PM information between the controller 11B and the end-to-end controller 12.

The resource information sharing device (sharing device) 22A has a function of sharing resource information necessary at the time of execution of the construction order of the network slice among the domains of the network via the resource information sharing channel. Specifically, the resource information sharing device 22A has a function of sharing resource information created in the domain A using the resource information sharing channel CH1 between the controller 11A and the controller 11B.

The resource information sharing device (sharing device) 22B has a function of sharing resource information necessary at the time of execution of the construction order of the network slice among the domains of the network via the resource information sharing channel. Specifically, the resource information sharing device 22B has a function of sharing resource information created in the domain B using the resource information sharing channel CH1 between the controller 11A and the controller 11B.

The FM/PM information registration device (registration device) 23A has a function of registering maintenance and operation information necessary for maintenance and operation of network resources in the network slice with respect to the FM/PM information sharing channel. Specifically, the FM/PM information registration device 23A has a function of registering the FM/PM information emanating from the domain A in the FM/PM information sharing channel CH2 (A).

The FM/PM information registration device (registration device) 23B has a function of registering maintenance and operation information necessary for maintenance and operation of network resources in the network slice with respect to the FM/PM information sharing channel. Specifically, the FM/PM information registration device 23A has a function of registering the FM/PM information emanating from the domain B in the FM/PM information sharing channel CH2 (B).

The FM/PM information acquisition device (acquisition device) 24 has a function of acquiring maintenance and operation information from a predetermined FM/PM information sharing channel among a plurality of FM/PM information sharing channels. Specifically, the FM/PM information acquisition device 24 has a function of acquiring the FM/PM information emanating from the domain A from the FM/PM information sharing channel CH2 (A) and acquiring the FM/PM information emanating from the domain B from the FM/PM information sharing channel CH2 (B).

### Operation of Management System; Distribution of Resource Information

A resource information distribution method will be described. The distribution of the resource information is executed at the time of constructing the network slice. The resource information is distributed by the channel management device 21 and the two resource information sharing devices 22A and 22B.

Hereinafter, a case where the construction order of the network slice is received and a case where the obsolete order of the network slice is received will be described. Note that the network slice includes logically or physically dividing one NW resource into a plurality of NW resources and further dividing the divided NW resources.

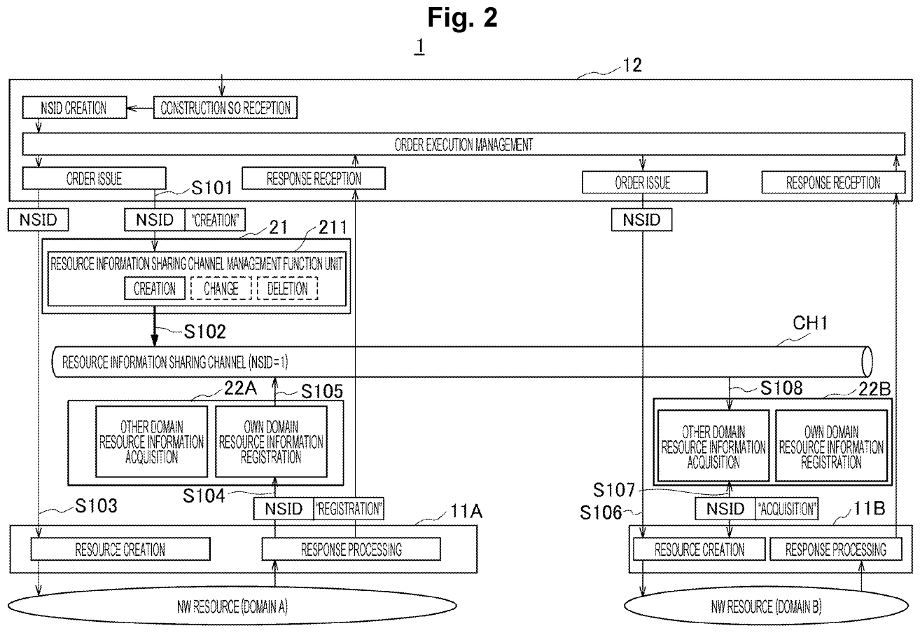

FIG. 2 is a diagram illustrating a flow of resource information distribution processing at the time of receiving a construction order.

Step S101;

First, the end-to-end controller 12 transmits the NSID for identifying the resource of the network slice to the resource information sharing channel management function unit 211 of the channel management device 21 with an order issue to the domain A to be called first as a trigger.

For example, the end-to-end controller 12 transmits

{“type”: “create”, “nsid”: “1”}.

Step S102:

Next, the resource information sharing channel management function unit 211 creates a resource information sharing channel CH1 of the NSID based on the received NSID.

For example, the resource information sharing channel management function unit 211 uses mosquitto, which is OSS of MQTT Broker, to create the resource information sharing channel CH1 called

broker (topic: /nsid/1). A topic is also created when mosquitto pub is executed. A character string including the NSID for identifying the resource of the network slice is used for topic which is the channel identifier of the resource information sharing channel CH1.

Steps S103 and S104;

Next, the controller 11A of the domain A receives the construction order including the NSID from the end-to-end controller 12, and passes the NSID included in the received construction order and the resource information created in the domain A to the resource information sharing device 22A of the domain A.

For example, the controller 11A passes

{“type”: “publish”, “nsid”: “1”, “ipaddr”: “192.168.1.1”}.

Step S105;

Next, the resource information sharing device 22A accesses the resource information sharing channel CH1 of the NSID based on the passed NSID, and registers information to be shared with another domain B (resource information created in its own domain A) in the accessed resource information sharing channel CH1.

For example, the resource information sharing device 22A executes a publish command of the mosquitto called

$mosquitto_pub-h<BrokerIP>-t/nsid/1-m “{“ipaddr”: “192.168.1.1”}”.

Steps S106 and S107;

The controller 11B of the domain B also receives the construction order including the NSID from the end-to-end controller 12 and passes the NSID included in the received construction order to the resource information sharing device 22B of the domain B.

For example, the controller 11B passes

{“type”: “subscribe”, “nsid”: “1”}.

Step S108;

Next, the resource information sharing device 22B accesses the resource information sharing channel CH1 of the NSID based on the passed NSID, and acquires information shared with the other domain A (resource information registered by the other domain A) from the accessed resource information sharing channel CH1.

For example, the resource information sharing device 22B executes a subscribe command of the mosquitto called:

$ mosquitto_sub-h<BrokerIP>-t/nsid/1.

Similarly, the resource information sharing device 22B can register information to be shared with another domain A (resource information created in its own domain B) in the resource information sharing channel CH1. The resource information sharing device 22A can acquire information (resource information registered by the other domain B) shared with the other domain B from the resource information sharing channel CH1.

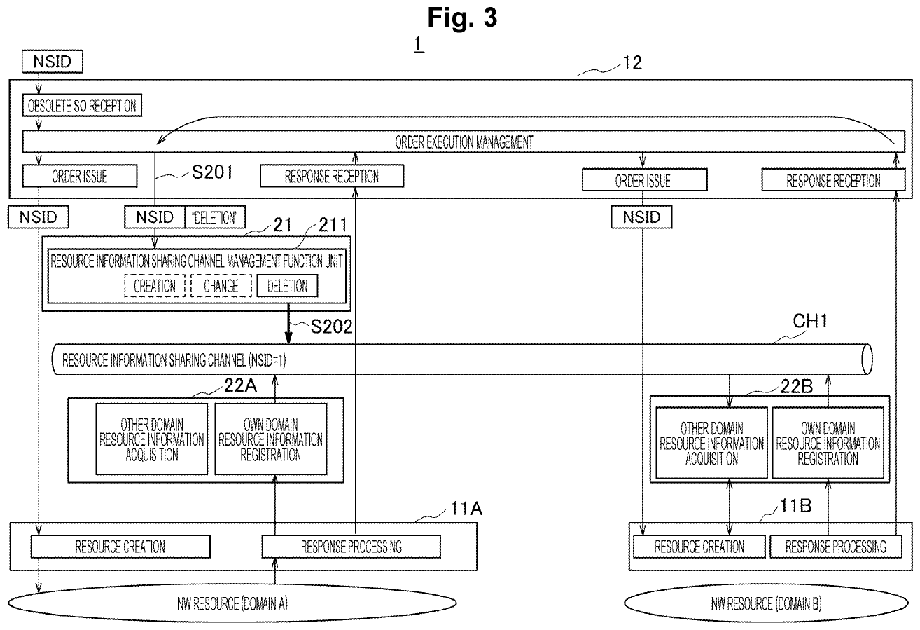

FIG. 3 is a diagram illustrating a processing flow at the time of receiving an obsolete order.

Step S201;

First, the end-to-end controller 12 transmits the NSID to be abolished to the resource information sharing channel management function unit 211 of the channel management device 21 with reception of a response from the domain B called last as a trigger.

Step S202;

Next, the resource information sharing channel management function unit 211 deletes a resource information sharing channel CH1 of the NSID based on the received NSID.

### Operation of Management System; Distribution of FM/PM Information

A FM/PM information distribution method will be described. The distribution of the FM/PM information is executed after the network slice is constructed in order to improve the efficiency of maintenance operation of the network slice. The distribution of the FM/PM information is executed by the channel management device 21, the two FM/PM information registration devices 23A and 23B, and the FM/PM information acquisition device 24.

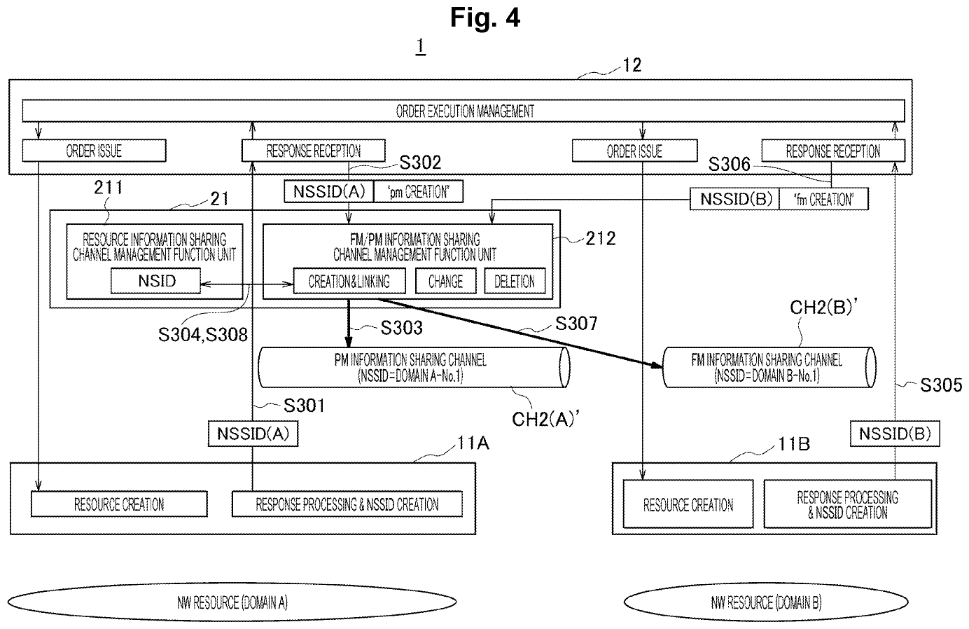

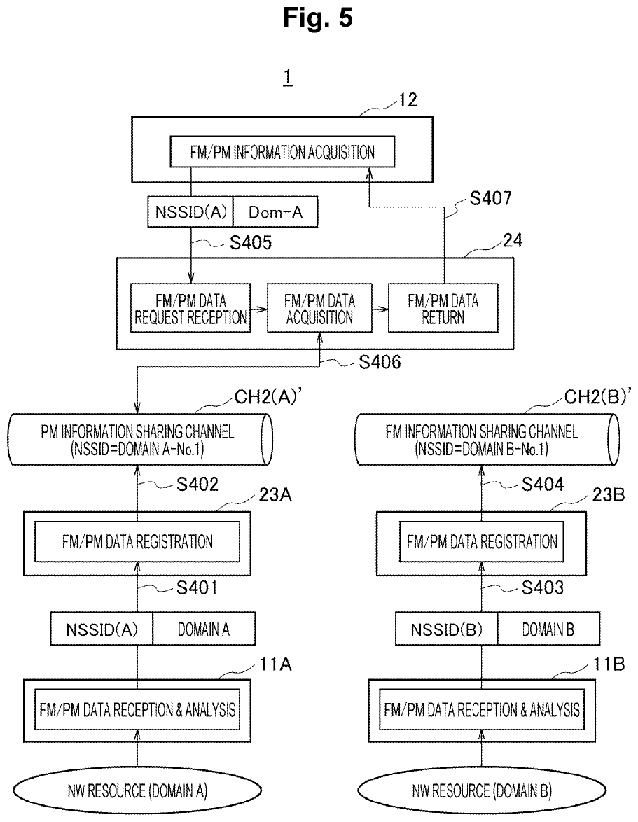

FIGS. 4 and 5 are diagrams illustrating the FM/PM information distribution processing flow. FIG. 4 is a processing flow until an FM/PM information sharing channel is created. FIG. 5 is a processing flow when FM/PM information is distributed.

Steps S301 and S302;

First, every time receiving a response from the domain A, the end-to-end controller 12 transmits an NSSID (A) for identifying a resource created in the domain A to the FM/PM information sharing channel management function unit 212 of the channel management device 21 together with a control command of “pm creation”.

Step S303;

Next, the FM/PM information sharing channel management function unit 212 creates the PM information sharing channel CH2 (A)′ of the NSSID (A) based on the received NSSID (A). At this time, the FM/PM information sharing channel management function unit 212 creates the FM information sharing channel when receiving the control command of “fm creation”, and creates the FM/PM information sharing channel when receiving the control command of “fm/pm creation”.

For example, the FM/PM information sharing channel management function unit 212 uses mosquitto, which is OSS of MQTT Broker, to create the PM information sharing channel CH2 (A)′ called:

broker (topic:/nsid/1/domA/pm/nssid/1). A topic is also created when mosquitto_pub is executed. In order to prevent naming duplication, a character string obtained by concatenating the NSSID created in the domain A and the domain name is used for topic which is the channel identifier of the PM information sharing channel CH2 (A)′.

Step S304;

Next, the FM/PM information sharing channel management function unit 212 associates the received NSSID (A) with the NSID held by the resource information sharing channel management function unit 211.

Steps S305 and S306;

Similarly, every time receiving a response from the domain B, the end-to-end controller 12 transmits the NSSID (B) for identifying the resource created in the domain B to the FM/PM information sharing channel management function unit 212 of the channel management device 21 together with the control command of “fm creation”.

Step S307;

Next, the FM/PM information sharing channel management function unit 212 creates the FM information sharing channel CH2 (B)′ of the NSSID (B) based on the received NSSID (B). At this time, the FM/PM information sharing channel management function unit 212 creates the PM information sharing channel when receiving the control command of “pm creation”, and creates the FM/PM information sharing channel when receiving the control command of “fm/pm creation”.

For example, the FM/PM information sharing channel management function unit 212 uses mosquitto, which is Oss of MQTT Broker, to create the FM information sharing channel CH2 (B)′ called:

broker (topic: /nsid/1/domB/fm/nssid/1). A topic is also created when mosquitto_pub is executed. In order to prevent naming duplication, a character string obtained by concatenating the NSSID created in the domain B and the domain name is used for topic which is the channel identifier of the FM information sharing channel CH2 (B)′.

Step S308;

Next, the FM/PM information sharing channel management function unit 212 associates the received NSSID (B) with the NSID held by the resource information sharing channel management function unit 211.

Note that the order of steps S301 to S304 and steps S305 to S308 may be reversed before and after each other, or may be executed simultaneously.

The case where channel creation is performed has been described above. In a case where the channel becomes unnecessary, the channel deletion is executed by the FM/PM information sharing channel management function unit 212. That is, the FM/PM information sharing channel management function unit 212 creates/deletes the FM/PM information sharing channels CH2 (A) and CH2 (B) for each NW resource created in each of the domains A and B.

Next, the FM/PM information distribution processing will be described with reference to FIG. 5.

Step S401;

After step S304, the controller 11A of the domain A passes the domain name, the NSSID (A), and the PM data emanating from the domain A to the FM/PM information registration device 23A of the domain A in the JSON format.

For example, the controller 11A of the domain A passes

{“domain”: “A”, “nssid”: “1”, “type”: “pm”, “throughput”: 300}.

Step S402;

Next, the FM/PM information registration device 23A registers the PM data emanating from the domain A in the PM information sharing channel CH2 (A)′ corresponding to the passed domain name and the NSSID (A).

For example, the FM/PM information registration device 23A executes a publish command of the mosquitto called:

$ mosquitto_pub-h<BrokerIP>-t/nsid/1/domA/pm/nssid1-m″ {“throughput”: 300}”.

Step S403;

Similarly, after step S308, the controller 11B of the domain B passes the domain name, the NSSID (B), and the FM data emanating from the domain B to the FM/PM information registration device 23B of the domain B in the JSON format.

For example, the controller 11B passes

{“domain”: “B”, “nssid”: “1”, “type”: “fm”, “alert”: “Delay is greater than a threshold value”}.

Step S404;

Next, the FM/PM information registration device 23B registers the FM data emanating from the domain B in the FM information sharing channel CH2 (B)′ corresponding to the passed domain name and the NSSID (B).

For example, the FM/PM information registration device 23B executes a publish command of the mosquitto called:

$ mosquitto_pub-h<BrokerIP>-t/nsid/1/domB/fm/nssid/1-m {“alert”: “Delay is greater than a threshold value”}.

Step S405;

Thereafter, the end-to-end controller 12 passes the domain name and the NSSID of the request target to the FM/PM information acquisition device 24. For example, in a case of requesting the PM data of the domain A, the end-to-end controller 12 passes the domain A, the NSSID (A), and the data type to the FM/PM information acquisition device 24.

For example, the end-to-end controller 12 passes

{“domain”: “A”, “type”: “pm”, “nssid”: “1”}.

Step S406;

The FM/PM information acquisition device 24 acquires the passed domain name and the FM/PM data emanating from the domain corresponding to the NSSID from the FM/PM information sharing channel corresponding to the NSSID. For example, in a case where the domain A, the NSSID (A), and the data type of PM are passed, the FM/PM information acquisition device 24 acquires PM data from the PM information sharing channel CH2 (A)′ corresponding to the NSSID (A).

For example, the FM/PM information acquisition device 24 executes a subscribe command of the mosquitto called:

$ mosquitto_sub-h<BrokerIP>-t/nsid/1/domA/pm/nssid/1.

Step S407;

Thereafter, the FM/PM information acquisition device 24 returns the acquired FM/PM data to the end-to-end controller 12. The end-to-end controller 12 acquires the FM/PM data of the domain requested in step S405. For example, the end-to-end controller 12 acquires FM/PM data emanating from the domain A.

For example, the end-to-end controller 12 acquires

{“domain”: “A”, “nssid”: “1”, “type”: “pm”, “throuput”: 300}.

### Effects of Embodiment

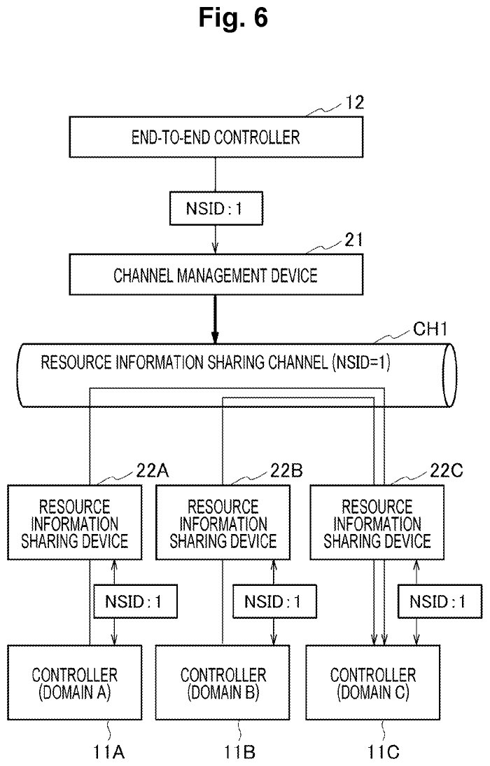

According to the present embodiment, as illustrated in FIG. 6, identifiers related to slice resources such as an NSID and an NSSID are distributed between the end-to-end controller 12 and the controllers 11A to 11C for each domain, and an information sharing channel according to the identifiers is dynamically created. Therefore, each of the controllers 11A to 11C can distribute resource information between domains without being conscious of endpoint information and formats.

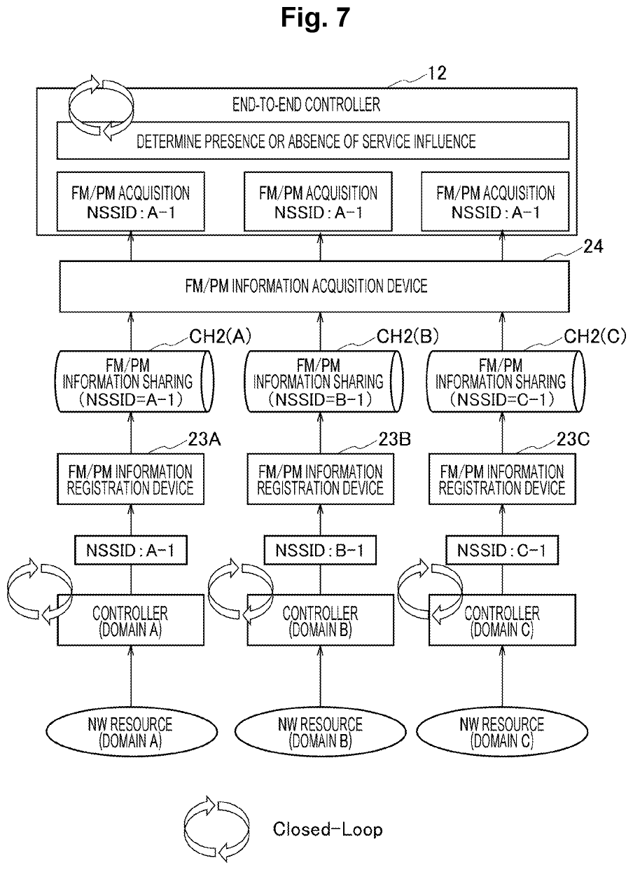

Furthermore, according to the present embodiment, as illustrated in FIG. 7, since the end-to-end controller 12 receives the FM/PM information for each domain and each NW resource from the constructed network slice, the end-to-end controller 12 can realize Closed Loop by a predetermined controller.

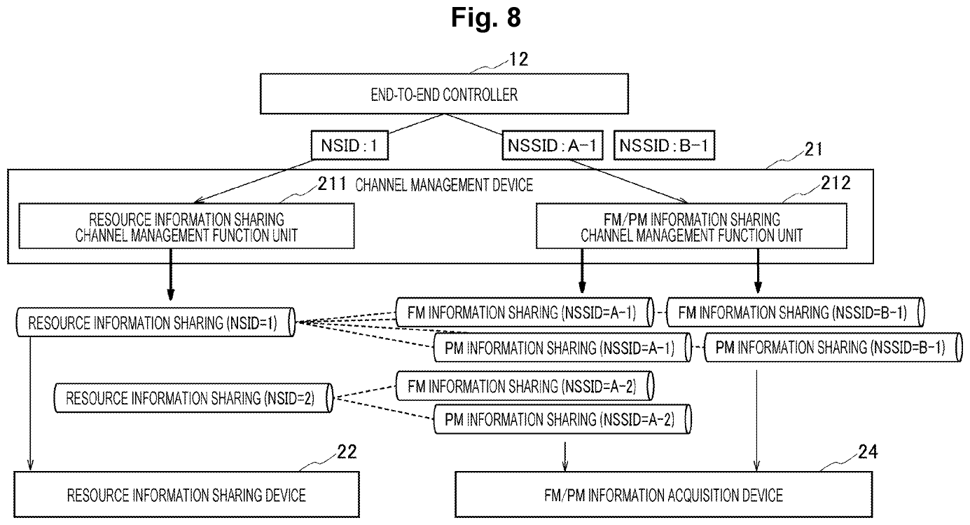

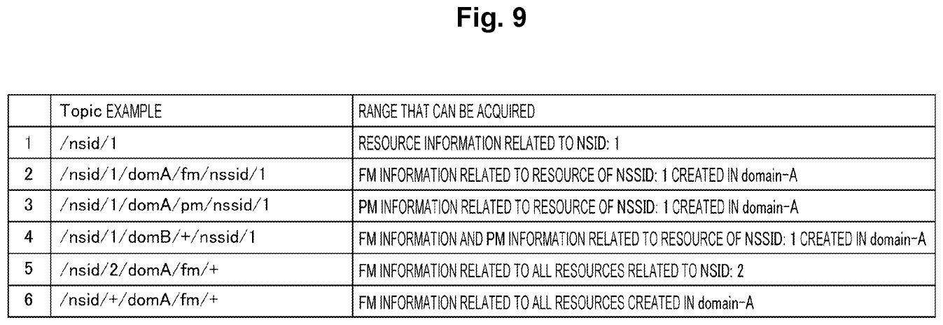

In addition, according to the present embodiment, as illustrated in FIG. 8, since the resource information sharing channel for each NSSID and the FM/PM information sharing channel for each NSID are integrally managed by the channel management device 21 in association with each other, when the resource information sharing device 22 or the FM/PM information acquisition device 24 acquires information, it is possible to designate a flexible information acquisition range such as a wildcard of MQTT (the ‘+’ notation illustrated in FIG. 9).

### Others

The present invention is not limited to the above embodiments. The present invention may be modified in various manners within the gist of the present invention.

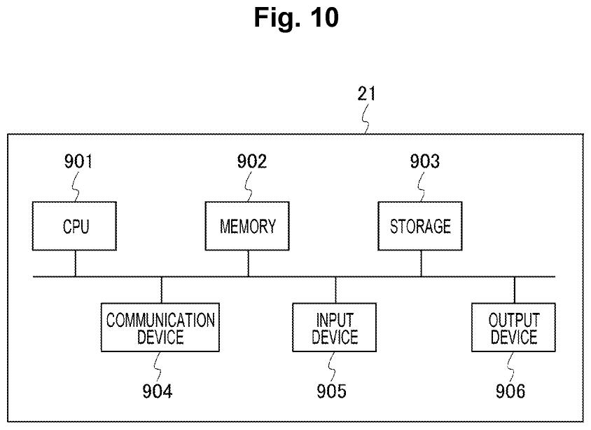

The channel management device 21 of the present embodiment described above can be implemented using, for example, a general-purpose computer system including a CPU 901, a memory 902, a storage 903, a communication device 904, an input device 905, and an output device 906 as illustrated in FIG. 10. The memory 902 and the storage 903 are storage devices. In the computer system, each function of the channel management device 21 is implemented by the CPU 901 executing a predetermined program loaded on the memory 902.

The channel management device 21 may be implemented by a single computer. The channel management device 21 may be implemented by a plurality of computers. The channel management device 21 may be a virtual machine that is implemented in a computer. The program for the channel management device 21 can be stored in a computer-readable recording medium such as HDDs, SSDs, USB memories, CDs, or DVDs. The program for the channel management device 21 can also be distributed via a communication network.

The resource information sharing devices 22A and 22B, the FM/PM information registration devices 23A and 23B, and the FM/PM information acquisition device 24 also have a hardware configuration similar to that of the channel management device 21.

### REFERENCE SIGNS LIST

1 Management system
11A to 11C Controller
12 End-to-end controller
21 Channel management device
211 Resource information sharing channel management function unit
212 EM/PM information sharing channel management function unit
22A to 22C Resource information sharing device
23A to 23C EM/PM information registration device
24 FM/PM information acquisition device
100 Terminal
200 Server
901 CPU
902 Memory
903 Storage
904 Communication device
905 Input device
906 Output device

1. A management system configured to manage resources of a network, the system comprising:
a management device, comprising one or more processors, configured to create an information sharing channel according to an identifier related to a network slice for each construction order of the network slice; and
a plurality of sharing devices, comprising one or more processors, configured to share resource information necessary at the time of execution of the construction order between domains of the network via the information sharing channel.

2. A management system configured to manage resources of a network, the system comprising:
a management device, comprising one or more processors, configured to create an information sharing channel according to an identifier related to a network slice for each network slice constructed in each domain of the network;
a plurality of registration devices, comprising one or more processors, configured to register maintenance and operation information necessary for maintenance and operation of a network resource in each network slice with respect to each of a plurality of the information sharing channels; and
an acquisition device, comprising one or more processors, configured to acquire the maintenance and operation information from a predetermined information sharing channel among the plurality of information sharing channels.

3. The management system according to claim 1, wherein
the management device is configured to associate an information sharing channel for sharing resource information necessary at the time of execution of a construction order of the network slice with an information sharing channel for sharing maintenance and operation information necessary for maintenance and operation of a network resource in the network slice.

4. (canceled)

5. A management method performed by a management system configured to manage resources of a network, the method comprising:
creating, by a management device, an information sharing channel according to an identifier related to a network slice for each network slice constructed in each domain of the network;
registering, by a plurality of registration devices, maintenance and operation information necessary for maintenance and operation of a network resource in each network slice with respect to each of a plurality of the information sharing channels; and
acquiring, by an acquisition device, the maintenance and operation information from a predetermined information sharing channel among the plurality of information sharing channels.

6. A non-transitory computer readable medium storing a program, wherein execution of the program causes a computer to function as the management system according to claim 1.
